(19) United States
(12) Patent Application Publication
(10) Pub. No.: US 2023/0202573 A1
(43) Pub. Date: Jun. 29, 2023

(54) BONDING STRUCTURE

(71) Applicant: HONDA MOTOR CO., LTD., Tokyo (JP)

(72) Inventors: Masaaki FUJIMOTO, Wako-shi (JP); Masahiro KAWAZU, Wako-shi (JP); Seiya OKAMURA, Wako-shi (JP)

(21) Appl. No.: 18/082,961

(22) Filed: Dec. 16, 2022

(30) Foreign Application Priority Data
Dec. 24, 2021 (JP) 2021-210675

(51) Int. Cl. B62D 25/04; B62D 27/02

(52) U.S. Cl. CPC B62D 25/04; B62D 27/02

(57) ABSTRACT

A bonding structure includes a flange bonding portion formed by bonding flanges of a front pillar inner member made of iron and of a front pillar stiffener made of iron to each other, and a dissimilar material bonding portion formed by bonding the front pillar stiffener to a front pillar outer member being an aluminum external plate. The dissimilar material bonding portion is disposed at an adjacent wall located away from the flange bonding portion of the front pillar stiffener and the front pillar inner member.

### CROSS-REFERENCE TO RELATED APPLICATION

This application is based upon and claims priority from the Japanese Patent Application No. 2021-210675, filed on Dec. 24, 2021, the entire contents of which are incorporated herein by reference.

### BACKGROUND OF THE INVENTION

### 1. Field of the Invention

The present invention relates to a bonding structure.

### 2. Description of the Related Art

There has long been known a bonding structure including a pair of roof side rails extending in a front-rear direction on outer sides in a vehicle width direction of a roof, and a center roof rail extending in the vehicle width direction between the roof side rails and being bonded to the roof side rails (see JP2005-153649A, for example). Each roof side rail in this bonding structure is formed from an inner member, a stiffener (a reinforcement), and an outer member. These members are integrated together by welding flanges provided to the respective members. Meanwhile, an inner member and an outer member of the center roof rail are bonded together to form a closed cross-section.

Moreover, in this bonding structure, a welded portion between an end portion of the outer member of the center roof rail and the stiffener is located away from a welded portion between an end portion of an end portion of the inner member of the center roof rail and the inner member of the roof side rail. Accordingly, the bonding structure improves an assembly performance of the center roof rail to the roof side rails.

### SUMMARY OF THE INVENTION

Meanwhile, in the bonding structure of the related art (see JP2005-153649A, for example), an aluminum material may possibly be applied to the outer member of each roof side rail for the purpose of reduction in weight of a vehicle body and for improvement of a design thereof.

However, this bonding structure involves dissimilar material bonding between the stiffener made of an iron material and the outer member made of the aluminum material. Accordingly, the bonding structure needs to secure a clearance between the outer member and the stiffener from the viewpoint of preventing the occurrence of galvanic corrosion at a non-bonded gap portion. If the clearance between the outer member and the stiffener is increased in this case, the area of the closed cross-section defined by the inner member and the stiffener needs to be decreased accordingly. In other words, the bonding structure of the related art (see JP2005-153649A, for example) may fail to secure sufficient rigidity due to the reduction in cross-sectional area of the closed cross-section defined by the inner member and the stiffener, which is supposed to significantly contribute to the rigidity of the roof side rail.

Given the circumstances, it is an object of the present invention to provide a bonding structure which achieves both improvement of fuel efficiency by reduction in weight and improvement of traffic safety by securing rigidity.

A bonding structure of the present invention to achieve the above-mentioned object includes a flange bonding portion formed by bonding flanges of an inner member made of iron and of a stiffener made of iron to each other; and a dissimilar material bonding portion formed by bonding the stiffener to an aluminum external plate disposed at the stiffener on an opposite side from the inner member, in which the dissimilar material bonding portion is formed at an adjacent wall of the stiffener, the adjacent wall extending from the flange of the stiffener through a first bent portion and being disposed to be adjacent to the first bent portion.

According to the present invention, it is possible to provide a bonding structure which achieves both improvement of fuel efficiency by reduction in weight and improvement of traffic safety by securing rigidity.

### BRIEF DESCRIPTION OF THE DRAWINGS

FIG. 1 is an explanatory diagram of a configuration of a vehicle body framework, which includes a bonding structure according to an embodiment of the present invention.

FIG. 2 is a cross-sectional view taken along the II-II line in FIG. 1.

FIG. 3A is a cross-sectional view taken along the IIIA-IIIA line in FIG. 1.

FIG. 3B is a cross-sectional view taken along the IIIB-IIIB line in FIG. 1.

### DETAILED DESCRIPTION OF THE EMBODIMENTS

Next, a mode for carrying out a bonding structure (an embodiment) of the present invention will be described in detail with reference to the drawings as appropriate. Note that front, rear, upper, lower, right, and left directions indicated with arrows in the drawings to be referred to coincide with front, rear, upper, lower, right, and left directions of a vehicle body. Here, a right-left direction of the vehicle body may be referred to as a vehicle width direction when appropriate.

A front pillar (an A-pillar) will be described below as an example of a bonding structure of the present embodiment. However, as will be described later in detail, the bonding structure of the present embodiment is not limited to the structure to be applied to the front pillar.

The bonding structures of the present embodiment are disposed on both right and left sides of a vehicle body so as to correspond to right and left front pillars, respectively. These bonding structures have bilaterally symmetric structures. Accordingly, the present embodiment will only discuss the bonding structure on the left side and detailed explanations of the bonding structure on the right side will be omitted.

A vehicle body framework to which the bonding structure of the present embodiment is applied will be described first and then the bonding structure will be described in detail.

«Configuration of Vehicle Body Framework»

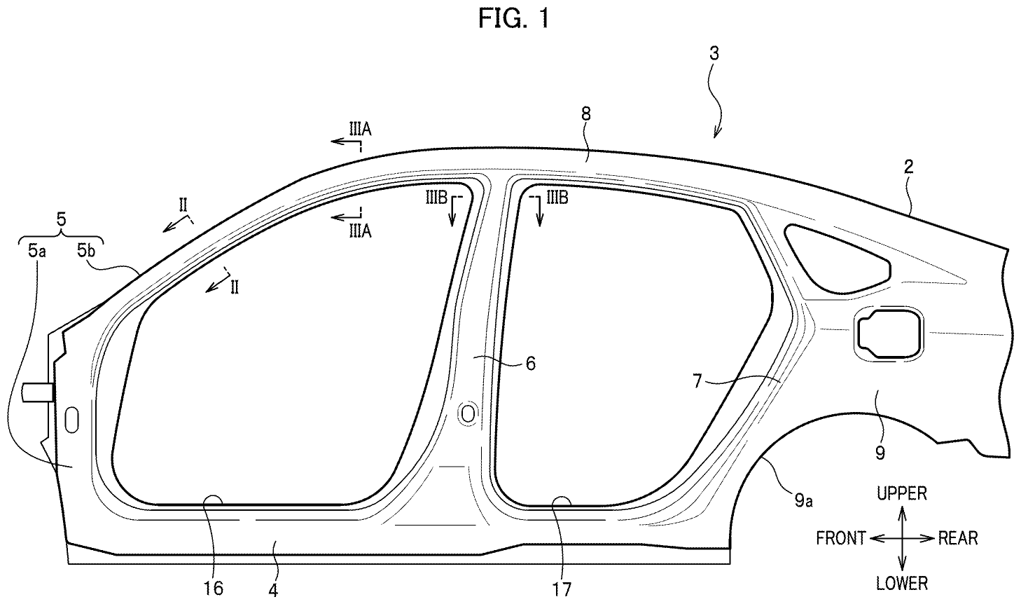

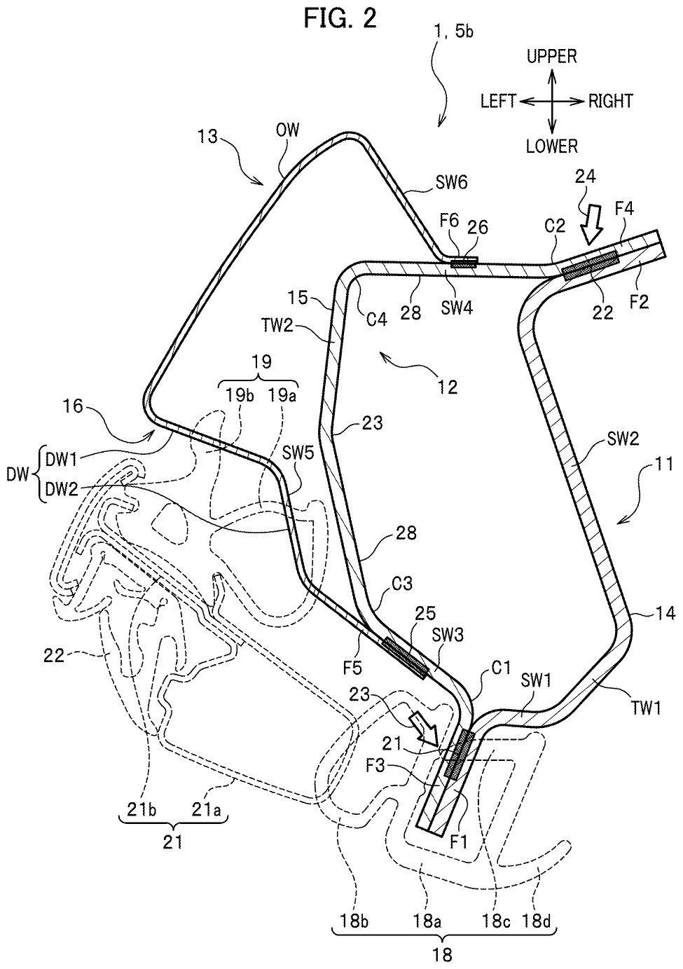

FIG. 1 is a left side view of a vehicle body framework 2 including a bonding structure 1 (see FIG. 2) according to the present embodiment.

As shown in FIG. 1, the vehicle body framework 2 of the present embodiment includes a side sill 4 extending in a front-rear direction on a lateral side of a vehicle body 3, a front pillar 5 extending upward from a front end portion of the side sill 4, a center pillar 6 extending upward from a central part in the front-rear direction of the side sill 4, and a rear pillar 7 extending upward from a rear end portion of the side sill 4.

The front pillar 5 includes a front pillar lower member 5a extending upward from the side sill 4, and a front pillar upper member 5b being inclined in such a way as to be gradually displaced rearward along with extending upward from an upper end of this front pillar lower member 5a.

The front pillar upper member 5b is connected to a roof rail 8 at an obliquely extending upper end thereof. Moreover, an upper end portion of the center pillar 6 and an upper end portion of the rear pillar 7 are connected to the roof rail 8 that extends rearward.

In the meantime, in the vehicle body 3, a door opening 16 to be closed with a front door (not shown) is formed on an inner side surrounded by the front pillar 5, the roof rail 8, the center pillar 6, and the side sill 4. Moreover, in the vehicle body 3, a door opening 17 to be closed with a rear door (not shown) is formed on an inner side surrounded by the rear pillar 7, the roof rail 8, the center pillar 6, and the side sill 4. These door openings 16 and 17 are provided with seal members 18 (see FIG. 2) referred to as weather strips to be described later.

In FIG. 1, reference sign 9 denotes a rear side panel provided with a rear wheel housing 9a. Incidentally, a laser welding method is mainly assumed as a method of bonding the vehicle body framework 2 of the present embodiment regarding not-illustrated component members of the front pillar upper member 5b, not-illustrated component members of the roof rail 8, and not-illustrated component members at an upper part of the center pillar 6. Meanwhile, any of a hem bonding method, a clinch bonding method, a spot welding method, a mechanical fastening method, and the like is assumed as a method of bonding not-illustrated vehicle body component members located on and behind the rear pillar 7. However, the bonding method of the vehicle body framework 2 can apply various methods except for those specified in the following description.

«Bonding Structure»

Next, the bonding structure 1 (see FIG. 2) of the present embodiment will be described.

FIG. 2 is a cross-sectional view taken along the II-II line in FIG. 1. In FIG. 2, reference sign 18 denotes the seal member provided to the door opening 16, and reference sign 19 denotes a seal member provided to a door sash 21. The seal member 18, the seal member 19, and the door sash 21 are indicated with virtual lines (dashed lines).

As shown in FIG. 2 representing a transverse sectional view of the front pillar upper member 5b (hereinafter simply referred to as a front pillar 5b), the front pillar 5b constituting the bonding structure 1 of the present embodiment includes a front pillar inner member 11, a front pillar stiffener 12, and a front pillar outer member 13.

The front pillar inner member 11 is formed from a bent plate body (a bent steel plate) made of iron, and corresponds to an “inner member” defined in the appended claims. The front pillar stiffener 12 is formed from a bent plate body (a bent steel plate) made of iron, and corresponds to a “stiffener” defined in the appended claims. The front pillar outer member 13 is formed from a bent plate body (a bent aluminum plate) made of aluminum, and corresponds to an “aluminum external plate” defined in the appended claims.

<Front Pillar Inner Member>

The front pillar inner member 11 substantially takes on a hat shape that is open outward in the vehicle width direction (the left side in FIG. 2) in the transverse sectional view shown in FIG. 2.

To be more precise, the front pillar inner member 11 includes a flange F1 and a flange F2 that correspond to brims of the hat shape.

The flange F1 is superposed on a flange F3 of the front pillar stiffener 12 to be described later, and is disposed on the door opening 16 side. The flange F2 is superposed on a flange F4 of the front pillar stiffener 12 to be described later, and approaches a left side end edge of a not-illustrated windshield.

Meanwhile, the front pillar inner member 11 includes a bulging portion 14 that bulges inward in the vehicle width direction (the right side in FIG. 2) so as to correspond to a crown portion of the hat shape. A side wall SW1 of this bulging portion 14 to be connected to the flange F1 is shorter than a side wall SW2 to be connected to the flange F2. Moreover, a top wall TW1 of the bulging portion 14 connects tip end portions of the side wall SW1 and the side wall SW2 to each other.

Here, an angle formed between the flange F2 and the side wall SW2 on a narrow angle side in the front pillar inner member 11 is set substantially equal to 90 degrees. Meanwhile, an angle formed between the flange F1 and the side wall SW1 on a narrow angle side is set to an angle slightly larger than 90 degrees.

<Front Pillar Stiffener>

The front pillar stiffener 12 substantially takes on a hat shape that is open inward in the vehicle width direction (the right side in FIG. 2) in the transverse sectional view shown in FIG. 2.

To be more precise, the front pillar stiffener 12 includes the flange F3 and the flange F4 that correspond to brims of the hat shape.

Meanwhile, the front pillar stiffener 12 includes a bulging portion 15 that bulges outward in the vehicle width direction (the left side in FIG. 2) so as to correspond to a crown portion of the hat shape.

A side wall SW3 of this bulging portion 15 to be connected to the flange F3 is set longer than the side wall SW1 to be connected to the flange F1 of the front pillar inner member 11 and shorter than the side wall SW2 to be connected to the flange F2 of the front pillar inner member 11.

A side wall SW4 of the bulging portion 15 to be connected to the flange F4 of the front pillar stiffener 12 is set longer than the side wall SW3 and shorter than the side wall SW2 of the front pillar inner member 11.

Moreover, a top wall TW2 of the bulging portion 15 connects tip end portions of the side wall SW3 and the side wall SW4 to each other.

The above-described top wall TW2 includes a bent portion 23 provided such that its central part in a direction of extension slightly projects outward in the vehicle width direction (the left side in FIG. 2).

Moreover, an angle formed between the flange F3 and the side wall SW3 on a narrow angle side in the front pillar stiffener 12 is set to an angle slightly larger than 90 degrees. Meanwhile, an angle formed between the flange F4 and the side wall SW4 on an outer angle side is set to an angle slightly smaller than 180 degrees.

In the above-described front pillar stiffener 12, each of a corner portion C1 formed by the flange F3 and the side wall SW3 and a corner portion C2 formed by the flange F4 and the side wall SW4 corresponds to a “first bent portion” defined in the appended claims. Meanwhile, each of a corner portion C3 formed by the side wall SW3 and the top wall TW2 and a corner portion C4 formed by the side wall SW4 and the top wall TW2 corresponds to a “second bent portion” defined in the appended claims. Moreover, adjacent walls 28 are formed between a central part of the bulging portion 15 and the corner portion C1 (the first bent portion) of the front pillar stiffener 12 and between the central part of the bulging portion 15 and the corner portion C2 (the first bent portion) thereof, respectively.

<Flange Bonding Portion>

Next, with reference to FIG. 2, a description will be given of flange bonding portions 21 and 22 formed by welding the flanges F1 and F2 of the front pillar inner member 11 to the flanges F3 and F4 of the front pillar stiffener 12.

The flange bonding portion 21 of the present embodiment is formed by welding the flange F1 of the front pillar inner member 11 and the flange F3 of the front pillar stiffener 12, which are superposed on each other. To be more precise, the flange bonding portion 21 is formed at an end portion 23 on the corner portion C1 (the first bent portion) side of the flanges F1 and F3 that are superposed on each other. In the present embodiment, the end portion 23 means a region on the corner portion C1 (the first bent portion) side relative to the central part in the direction of extension of the flanges F1 and F3.

Meanwhile, the flange bonding portion 22 is formed at an end portion 24 on the corner portion C2 (the first bent portion) side of the flanges F2 and F4 that are superposed on each other. In the present embodiment, the end portion 24 means a region on the corner portion C2 (the first bent portion) side relative to the central part in the direction of extension of the flanges F2 and F4.

The front pillar inner member 11 and the front pillar stiffener 12 bonded to each other at the above-described flange bonding portions 21 and 22 form a closed cross-section of a substantially rectangular shape inside thereof, which is elongate in one direction in the transverse sectional view shown in FIG. 2.

The above-described flange bonding portions 21 and 22 of the present embodiment are assumed to be bonded together by laser welding.

<Front Pillar Outer Member>

Next, the front pillar outer member 13 (see FIG. 2) will be described.

The front pillar outer member 13 substantially takes on a horseshoe shape (substantially takes on a C-shape) in the transverse sectional view shown in FIG. 2. To be more precise, the front pillar outer member 13 includes a flange F5 bonded to the side wall SW3 of the front pillar stiffener 12, a flange F6 bonded to the side wall SW4 of the front pillar stiffener 12, a side wall SW5 extending outward in the vehicle width direction (the left side in FIG. 1) from the flange F5, a side wall SW6 extending outward in the vehicle width direction (the left side in FIG. 1) from the flange F6, and an outer wall OW forming a designed surface of the front pillar 5b by bonding connecting tip end portions of the side wall SW5 and the side wall SW6 to each other.

The flange F5 is partially superposed on the side wall SW3 of the front pillar stiffener 12, and extends further outward in the vehicle width direction (the left side in FIG. 1) along the direction of extension of the side wall SW3.

The side wall SW5 is provided with a concave surface DW that comes into contact with the seal member 19 (the weather strip) attached to the door sash 21 of the front door (not shown).

This concave surface DW is formed from a first wall DW1 that is located away at a predetermined interval from and extends parallel to the top wall TW2 of the front pillar stiffener 12 based on a tip end portion of the flange F5, and a second wall DW2 that extends outward in the vehicle width direction (the left side in FIG. 2) in a bent manner at a position substantially corresponding to the bent portion 23 of the top wall TW2.

The flange F6 is formed in a shorter length than the side wall SW4 to the extent that is bondable by the laser welding to be described later in such a way as to form a rise of the side wall SW6 in the middle of the side wall SW4 of the front pillar stiffener 12.

The side wall SW6 extends from the flange F6 while forming such an angle that spreads at a predetermined angle from the second wall DW2 that forms the side wall SW5, thereby securing a large lateral width of the outer wall OW that constitutes the designed surface. The seal member 19 (the weather strip) will be described later in detail.

<Dissimilar Material Bonding Portions>

As shown in FIG. 2, the flanges F5 and F6 of the front pillar outer member 13 form dissimilar material bonding portions 25 and 26 with the front pillar stiffener 12.

These dissimilar material bonding portions 25 and 26 are formed at the adjacent walls 28 of the front pillar stiffener 12.

To be more precise, the dissimilar material bonding portion 25 is disposed on the corner portion C1 (the first bent portion) side of the side wall SW3 of the front pillar stiffener 12. The dissimilar material bonding portion 26 is disposed on the corner portion C2 (the first bent portion) side of the side wall SW4 of the front pillar stiffener 12.

Moreover, the dissimilar material bonding portion 25 is preferably disposed between the corner portion C1 (the first bent portion) and the corner portion C3 (the second bent portion). Meanwhile, the dissimilar material bonding portion 26 is disposed between the corner portion C2 (the first bent portion) and the corner portion C4 (the second bent portion). The dissimilar material bonding portions 25 and 26 of the present embodiment are assumed to be formed by the laser welding. Moreover, such laser-welded portions 27 are formed so as to include at least tip end portions of the flanges F5 and F6 of the front pillar outer member 13 as shown in FIG. 2.

In addition, the dissimilar material bonding portions 25 and 26 of the present embodiment are opposed to each other in such a way as to interpose the closed cross-section defined by the front pillar stiffener 12 and the front pillar inner member 11 in between in a longitudinal direction thereof.

<Seal Members>

As shown in FIG. 2, the above-mentioned seal members 18 and 19 (the weather strips) are attached to the vehicle body 3 (see FIG. 1) of the present embodiment.

Although illustration is omitted, the seal member 18 is an elongate member to be disposed along the door opening 16 of the vehicle body 3.

As shown in FIG. 2, the seal member 18 mainly includes a base portion 18a formed substantially into a U-shape in a transverse sectional view and configured to be fitted and attached to the flanges F1 and F3 that are superposed to each other, a hollow sealing portion 18b formed integrally with this base portion 18a and bulging outward in the vehicle width direction (the left side in FIG. 2) of the flanges F1 and F3, a first lip portion 18c that comes into contact with the flanges F1 and F3 pinched with the base portion 18a on an open side of the substantially U-shaped base portion 18a, and a second lip portion 18d that extends inward in the vehicle width direction (the right side in FIG. 2) from a closed side of the substantially U-shaped base portion 18a. This seal member 18 corresponds to a “seal member” defined in the appended claims.

The hollow sealing portion 18b of the above-described seal member 18 comes into contact with a tubular portion 21a of the door sash 21 when the front door (not shown) is closed. Meanwhile, the hollow sealing portion 18b is disposed alongside of the side wall SW3 of the front pillar stiffener 12 while locating the tip end portion of the flange F5 of the front pillar outer member 13 in between when the front door (not shown) is opened.

Incidentally, although illustration is omitted, the second lip portion 18d comes into contact with an end edge of a pillar garnish that covers a curtain airbag system to be disposed on an inner side in the vehicle width direction (the right side in FIG. 2) of the front pillar inner member 11.

The seal member 19 is attached to a molding forming portion 21b having a T-shape in a transverse sectional view, which extends from the tubular portion 21a of the door sash 21. The seal member 19 is attached to the door sash 21 on an opposite side from a window glass seal member 22.

The above-described seal member 19 includes a hollow sealing portion 19a that comes into contact with the first wall DW1 constituting the concave surface DW of the front pillar outer member 13 in a case where the front door (not shown) is closed, and a lip portion 19b that comes into contact with the second wall DW2 in this case.

«Operation and Effects»

The operation and effects exerted by the bonding structure 1 according to the present embodiment will be described below.

In general, on the assumption that a vehicle body framework member is formed by pinching a stiffener (a reinforcement member) made of iron between an inner member made of iron and an outer member made of aluminum, this vehicle body framework member is thought to be integrated together by welding three flanges of the respective components.

In the above-described vehicle body framework member, the flange of the outer member and the flange of the stiffener constitute a dissimilar material bonding portion (a dissimilar metal welding portion).

However, in the vehicle body framework member having the above-mentioned dissimilar material bonding portion, the body of the stiffener needs to be located away from the body of the outer member from the viewpoint of preventing galvanic corrosion based on a difference in ionization tendency between iron and aluminum. Specifically, the flange of the outer member needs to be offset from the flange bonding portions of the stiffener and the inner member in a direction to move the body of the outer member away from the body of the stiffener.

However, in the above-mentioned vehicle body framework member, the lengths of the flanges of the stiffener and the inner member for bonding the flanges are increased in accordance with a distance of offsetting the flange of the outer member. In other words, the weight of the vehicle body framework member cannot be reduced efficiently.

Meanwhile, in the vehicle body framework member including the above-mentioned dissimilar material bonding portion, the area of a closed section defined between the inner member and the stiffener becomes smaller than the area of a closed cross-section defined between the outer member and the stiffener as a consequence of locating the body of the outer member away from the body of the stiffener. In other words, the vehicle body framework member including the dissimilar material bonding portion may fail to impart sufficient rigidity because of the reduction in cross-sectional area of the closed cross-section defined between the inner member and the stiffener, which is supposed to significantly contribute to the rigidity of the vehicle body framework member.

On the other hand, in the bonding structure 1 of the present embodiment, the dissimilar material bonding portions 25 and 26 are disposed at the adjacent walls 28 that are located away from the flange bonding portions 21 and 22 of the front pillar stiffener 12 (the stiffener) and the front pillar inner member 11 (the inner member).

According to the above-described bonding structure 1, it is possible to keep the flanges F1, F2, F3, and F4 from increasing the lengths by disposing the dissimilar material bonding portions 25 and 26 at the adjacent wall 28.

According to the bonding structure 1, the disposition of the dissimilar material bonding portions 25 and 26 at the adjacent walls 28 makes it possible to reduce a space (a region) that would be required for locating the front pillar outer member 13 (the aluminum external plate) away from the front pillar stiffener 12 (the stiffener). Thus, it is possible to suppress electric corrosion of the front pillar outer member 13 (the aluminum external plate) without reducing the area of the closed cross-section defined by the front pillar inner member 11 (the inner member) and the front pillar stiffener 12 (the stiffener).

As a consequence, the bonding structure 1 can impart the sufficient rigidity to the front pillar 5b which is the vehicle body framework member.

According to the bonding structure 1, the disposition of the dissimilar material bonding portions 25 and 26 at the adjacent walls 28 makes it possible to reduce the lengths of the flanges F1 and F3 that approach the door opening 16 side. Thus, it is possible to set the wide door opening 16 in the bonding structure 1.

Meanwhile, in the above-described bonding structure 1, the dissimilar material bonding portions 25 and 26 are formed by the laser welding. Moreover, the dissimilar material bonding portion 25 is disposed on the corner portion C1 (the first bent portion) side of the adjacent wall 28, or in other words, at the tip end portion of the flange F5. Meanwhile, the dissimilar material bonding portion 26 is disposed on the corner portion C2 (the first bent portion) side of the adjacent wall 28, or in other words, at the tip end portion of the flange F6.

According to the above-described bonding structure 1, the formation of the dissimilar material bonding portions 25 and 26 by the laser welding makes it possible to bond the front pillar outer member 13 (the aluminum external plate) without relying on material strengths and plate thicknesses of the front pillar stiffener 12 (the stiffener) and the front pillar inner member 11 (the inner member). In other words, according to the bonding structure 1, it is possible to apply high strength materials to the front pillar stiffener 12 (the stiffener) and the front pillar inner member 11 (the inner member).

According to the above-described bonding structure 1, it is possible to reduce the lengths of the flanges F5 and F6 by forming the dissimilar material bonding portions 25 and 26 by the laser welding and forming the dissimilar material bonding portions 25 and 26 on the corner portion C1 (the first bent portion) side and the corner portion C2 (the first bent portion) side.

In this way, the bonding structure 1 can achieve the reduction in weight of the front pillar 5b.

By reducing the lengths of the flanges F5 and F6, the bonding structure 1 can increase the area of the closed cross-section defined by the front pillar outer member 13 (the aluminum external plate) and the front pillar stiffener 12 (the stiffener) without reducing the area of the closed cross-section defined by the front pillar inner member 11 (the inner member) and the front pillar stiffener 12 (the stiffener). As a consequence, it is possible to increase the area of the closed cross-section of the entire front pillar 5b, thereby further enhancing the rigidity of the front pillar 5b.

According to the bonding structure 1, it is possible to dispose the corner portion C1 (the first bent portion) adjacently by forming the dissimilar material bonding portion 25 at the tip end portion of the flange F5.

The above-described bonding structure 1 can conceal the dissimilar material bonding portion 25 with the seal member 18, thereby improving appearance of the bonding structure 1.

According to the above-described bonding structure 1, the dissimilar material bonding portion 25 is formed between the corner portion C1 (the first bent portion) and the corner portion C3 (the second bent portion), and the dissimilar material bonding portion 26 is formed between the corner portion C2 (the first bent portion) and the corner portion C4 (the second bent portion).

The above-described bonding structure 1 can more reliably dispose the dissimilar material bonding portions 25 and 26 close to the corner portions C1 and C2 (the first bent portions) of the adjacent walls 28, respectively.

According to the above-described bonding structure 1, the flange bonding portion 21 is formed at the end portion 23 on the corner portion C1 (the first bent portion) side of the flanges F1 and F3 that are superposed on each other, and the flange bonding portion 22 is formed at the end portion 24 on the corner portion C2 (the first bent portion) side of the flanges F2 and F4 that are superposed on each other.

The above-described bonding structure 1 can set short lengths for the flanges F1 and F3 as well as the flanges F2 and F4, thereby securing the large area of the closed cross-section defined by the front pillar inner member 11 (the inner member) and the front pillar stiffener 12 (the stiffener). In this way, the bonding structure 1 can enhance the rigidity of the front pillar 5b more reliably.

Moreover, since the bonding structure 1 can reduce the lengths of the flanges F1 and F3, it is possible to secure the larger area of the door opening 16.

In the above-described bonding structure 1, the flange bonding portions 21 and 22 are provided with the laser-welded portions.

In this bonding structure 1, the flanges F1 and F3 are bonded to each other by the laser welding, so that the flange bonding portion 21 can be formed closer to the corner portion C1 (the first bent portion). Meanwhile, the flanges F2 and F4 are bonded to each other by the laser welding, so that the flange bonding portion 22 can be formed closer to the corner portion C2 (the first bent portion).

According to the above-described bonding structure 1, the flanges F1 and F3 as well as the flanges F2 and F4 can more reliably be set shorter.

In the above-described bonding structure 1, the seal member 18 is provided to the surface on the adjacent wall 28 side of the flange bonding portion 21.

According to the above-described bonding structure 1, the dissimilar material bonding portion 25 and the flange bonding portion 21 can be concealed with the seal member 18. Thus, the bonding structure 1 can improve its design and an assembly performance of the front pillar outer member 13 (the aluminum external plate) with the front pillar stiffener 12 (the stiffener).

According to the bonding structure 1, the tip end portion of the front pillar outer member 13 (the aluminum external plate) can be concealed with the seal member 18. For this reason, it is not necessary to extend the flange F5 of the front pillar outer member 13 to the tip end portion of the flange F3 of the front pillar stiffener 12 (the stiffener). Thus, the bonding structure 1 can set the short flange F5.

Meanwhile, according to the bonding structure 1 of the present embodiment, it is possible to efficiently support an impact load attributed to a front or rear collision with a vehicle thanks to the high rigidity that is brought about by applying the bonding structure 1 to the front pillar 5b.

Moreover, it is possible to secure the large door opening 16 by applying the bonding structure 1 of the present embodiment to the front pillar 5b. This configuration brings about a nice view from the inside of the vehicle when the door is opened.

While the embodiment of the present invention has been described above, the present invention is not limited only to the above-described embodiment and various other modes can be embodied as well.

Next, a first modified example of the bonding structure 1 (see FIG. 2) of the embodiment will be described.

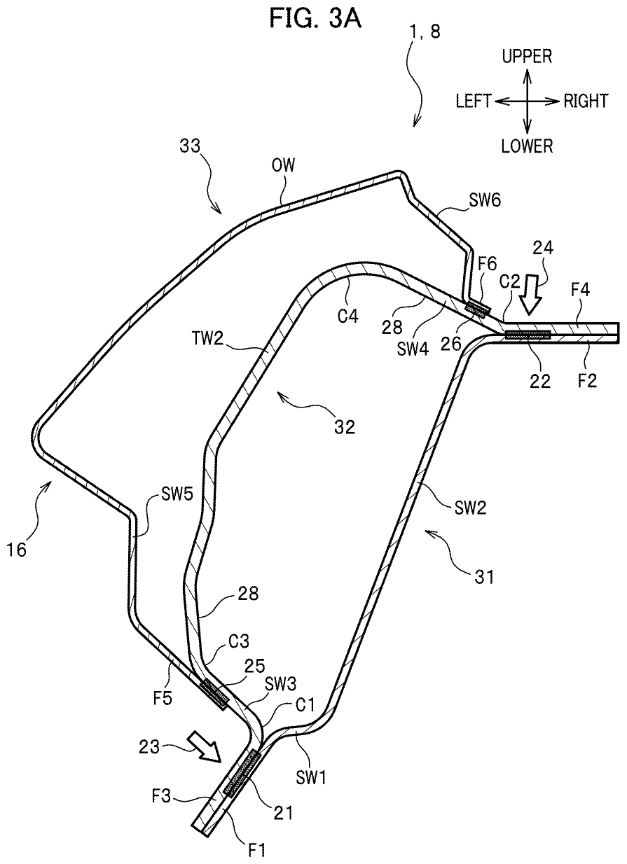

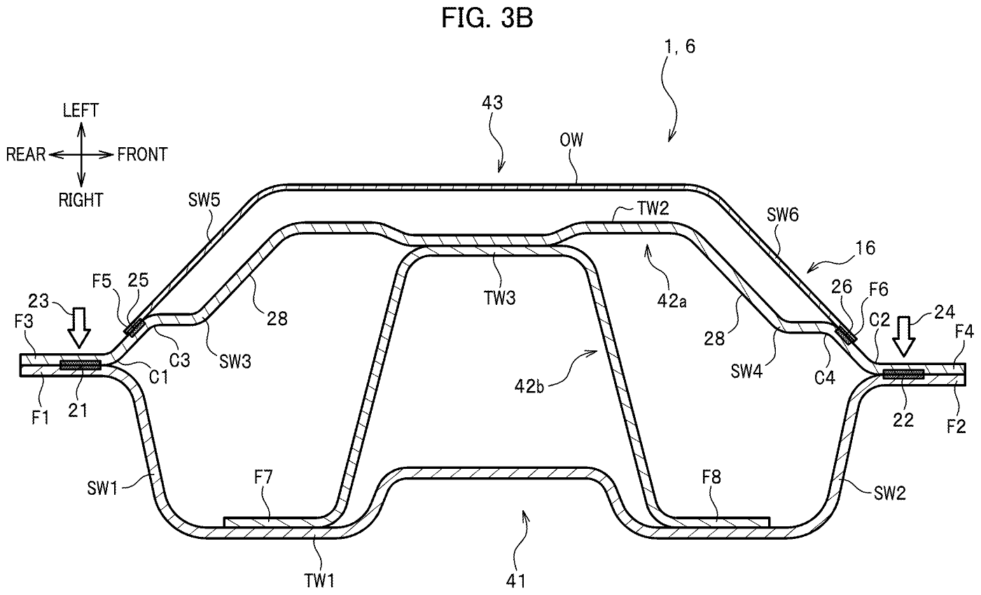

FIG. 3A is a cross-sectional view taken along the IIIA-IIIA line in FIG. 1, which is a transverse sectional view of the roof rail 8 (see FIG. 1). In the bonding structure 1 of the first modified example, the same constituents as those in the above-described embodiment will be denoted by the same reference signs and detailed explanations thereof will be omitted.

As shown in FIG. 3A, the bonding structure 1 according to the first modified example applied to the roof rail 8 includes a roof rail inner member 31, a roof rail stiffener 32, and a roof rail outer member 33.

In the bonding structure 1 of the first modified example, the roof rail inner member 31 corresponds to the front pillar inner member 11 of the above-described embodiment, the roof rail stiffener 32 corresponds to the front pillar stiffener 12 of the embodiment, and the roof rail outer member 33 corresponds to the front pillar outer member 13 of the embodiment.

Specifically, the roof rail inner member 31 corresponds to the “inner member” defined in the appended claims. The roof rail stiffener 32 corresponds to the “stiffener” defined in the appended claims. The roof rail outer member 33 corresponds to the “aluminum external plate” defined in the appended claims.

As shown in FIG. 3A, in the bonding structure 1 according to the first modified example, the dissimilar material bonding portions 25 and 26 are disposed at the adjacent walls 28 located away from the flange bonding portions 21 and 22 of the roof rail stiffener 32 (the stiffener) and the roof rail inner member 31 (the inner member).

Meanwhile, in the bonding structure 1 according to the first modified example, the dissimilar material bonding portions 25 and 26 are formed by the laser welding. Moreover, the dissimilar material bonding portion 25 is disposed on the corner portion C1 (the first bent portion) side of the adjacent wall 28, or in other words, at the tip end portion of the flange F5. In the meantime, the dissimilar material bonding portion 26 is disposed on the corner portion C2 (the first bent portion) side of the adjacent wall 28, or in other words, at the tip end portion of the flange F6.

In the bonding structure 1 according to the first modified example, the dissimilar material bonding portion 25 is formed between the corner portion C1 (the first bent portion) and the corner portion C3 (the second bent portion), and the dissimilar material bonding portion 26 is formed between the corner portion C2 (the first bent portion) and the corner portion C4 (the second bent portion).

In addition, in the bonding structure 1 according to the first modified example, the flange bonding portion 21 is formed at the end portion 23 on the corner portion C1 (the first bent portion) side of the flanges F1 and F3 that are superposed on each other, and the flange bonding portion 22 is formed at the end portion 24 on the corner portion C2 (the first bent portion) side of the flanges F2 and F4 that are superposed on each other.

The bonding structure 1 according to the first modified exampled configured as described above can exert the same operation and effects as those of the above-described embodiment.

Next, a second modified example of the bonding structure 1 (see FIG. 2) of the embodiment will be described.

FIG. 3B is a cross-sectional view taken along the IIIB-IIIB line in FIG. 1, which is a transverse sectional view of an upper part of the center pillar 6 (see FIG. 1). In the bonding structure 1 of the second modified example, the same constituents as those in the above-described embodiment will be denoted by the same reference signs and detailed explanations thereof will be omitted.

As shown in FIG. 3B, the bonding structure 1 according to the second modified example applied to the center pillar 6 includes a center pillar inner member 41, a first center pillar stiffener 42a, a second center pillar stiffener 42b, and a center pillar outer member 43.

In the bonding structure 1 of the second modified example, the center pillar inner member 41 corresponds to the front pillar inner member 11 of the above-described embodiment, the first center pillar stiffener 42a corresponds to the front pillar stiffener 12 of the embodiment, and the center pillar outer member 43 corresponds to the front pillar outer member 13 of the embodiment.

Specifically, the center pillar inner member 41 corresponds to the “inner member” defined in the appended claims. The first center pillar stiffener 42a corresponds to the “stiffener” defined in the appended claims. The center pillar outer member 43 corresponds to the “aluminum external plate” defined in the appended claims.

Here, the second center pillar stiffener 42b takes on a hat shape that is open inward in the vehicle width direction (the right side in FIG. 3B) in the transverse sectional view shown in FIG. 3B. A top wall TW3 of the second center pillar stiffener 42b is connected to the first center pillar stiffener 42a by the laser welding. Meanwhile, a pair of flanges F7 and F8 of the second center pillar stiffener 42b are connected to the center pillar inner member 41 by the laser welding.

As shown in FIG. 3B, in the bonding structure 1 according to the second modified example, the dissimilar material bonding portions 25 and 26 are disposed at the adjacent walls 28 located away from the flange bonding portions 21 and 22 of the first center pillar stiffener 42a (the stiffener) and the center pillar inner member 41 (the inner member).

Meanwhile, in the bonding structure 1 according to the second modified example, the dissimilar material bonding portions 25 and 26 are formed by the laser welding. Moreover, the dissimilar material bonding portion 25 is disposed on the corner portion C1 (the first bent portion) side of the adjacent wall 28, or in other words, at the tip end portion of the flange F5. In the meantime, the dissimilar material bonding portion 26 is disposed on the corner portion C2 (the first bent portion) side of the adjacent wall 28, or in other words, at the tip end portion of the flange F6.

In the bonding structure 1 according to the second modified example, the dissimilar material bonding portion 25 is formed between the corner portion C1 (the first bent portion) and the corner portion C3 (the second bent portion), and the dissimilar material bonding portion 26 is formed between the corner portion C2 (the first bent portion) and the corner portion C4 (the second bent portion).

In addition, in the bonding structure 1 according to the second modified example, the flange bonding portion 21 is formed at the end portion 23 on the corner portion C1 (the first bent portion) side of the flanges F1 and F3 that are superposed on each other, and the flange bonding portion 22 is formed at the end portion 24 on the corner portion C2 (the first bent portion) side of the flanges F2 and F4 that are superposed on each other.

The bonding structure 1 according to the second modified exampled configured as described above can exert the same operation and effects as those of the above-described embodiment.

The flange bonding portions 21 and 22 in the above-described embodiment are assumed to be bonded by the laser welding. Instead of the laser welding, the flange bonding portions 21 and 22 can also be formed by spot welding.

This bonding structure 1 can enrich bonding measures applicable to the flange bonding portions 21 and 22.

Meanwhile, the dissimilar material bonding portions 25 and 26 in the above-described embodiment are assumed to be bonded by the laser welding. Instead of the laser welding, the dissimilar material bonding portions 25 and 26 can also be formed by mechanical fastening with self-piercing rivets (SPR) and the like.

This bonding structure 1 can enrich bonding measures applicable to the dissimilar material bonding portions 25 and 26.

What is claimed is:

1. A bonding structure comprising:
a flange bonding portion formed by bonding flanges of an inner member made of iron and of a stiffener made of iron to each other; and
a dissimilar material bonding portion formed by bonding the stiffener to an aluminum external plate disposed at the stiffener on an opposite side from the inner member, wherein
the dissimilar material bonding portion is formed at an adjacent wall of the stiffener, the adjacent wall extending from the flange of the stiffener through a first bent portion and being disposed to be adjacent to the first bent portion.

2. The bonding structure according to claim 1, wherein the dissimilar material bonding portion is formed by laser welding, and is disposed on the first bent portion side of the adjacent wall.

3. The bonding structure according to claim 2, wherein
the stiffener further includes a second bent portion being bent in mid-course of extension of the adjacent wall from the first bent portion, and
the dissimilar material bonding portion is formed between the first bent portion and the second bent portion.

4. The bonding structure according to claim 1, wherein the flange bonding portion is formed at an end portion on the first bent portion side of each flange.

5. The bonding structure according to claim 3, further comprising:
a seal member provided on a surface on the adjacent wall side of the flange bonding portion.

6. The bonding structure according to claim 5, wherein
the inner member, the stiffener, and the aluminum external plate are integrated together to form a vehicle body framework member, and
the vehicle body framework member is any of a front pillar, a roof rail, and a center pillar which constitute at least part of a door opening.

7. The bonding structure according to claim 3, wherein the flange bonding portion includes a laser-welded portion.

8. The bonding structure according to claim 3, wherein the flange bonding portion includes a spot-welded portion.

9. The bonding structure according to claim 1, wherein the dissimilar material bonding portion includes a mechanical fastening structure.
